(19) United States
(12) Patent Application Publication
(10) Pub. No.: US 2018/0262739 A1
(43) Pub. Date: Sep. 13, 2018

(54) OBJECT DETECTION SYSTEM

(71) Applicant: DENSO International America, Inc., Southfield, MI (US)

(72) Inventor: Shawn HUNT, Pinckney, MI (US)

(21) Appl. No.: 15/455,656

(22) Filed: Mar. 10, 2017

(51) Int. Cl. H04N 13/02; G06K 9/00; G06T 17/00; G06K 9/62; G06T 7/11

(52) U.S. Cl. CPC H04N 13/0221; G06K 9/00791; G06T 17/00; G06T 2207/30252; G06K 9/6298; G06T 7/11; G06K 9/6212

(57) ABSTRACT

A three-dimensional imaging system for imaging an object of interest present in an area about a vehicle. The system includes a camera and a control module. The camera is configured to capture an image of the area about the vehicle including the object of interest. A control module of the system compares the captured image to previously captured model images including examples of the object of interest. The control module also identifies the object of interest in the captured image based on the comparison, and builds a three-dimensional reconstruction of the object of interest.

### FIELD

The present disclosure relates to an object detection system, such as an object detection system for vehicles that performs three-dimensional reconstruction of select objects of interest.

### BACKGROUND

This section provides background information related to the present disclosure, which is not necessarily prior art.

Some vehicle safety systems and autonomous driving systems use three-dimensional scene reconstruction of an entire environment around a vehicle. While current three-dimensional scene reconstruction systems are suitable for their intended use, they are subject to improvement. For example, current systems three-dimensionally reconstruct an entire scene captured by a camera, which requires an extensive amount of processing power and processing time making it sometimes difficult for the system to operate optimally when the vehicle is traveling at high speed. The present teachings address these issues with current three-dimensional systems, as well as numerous other issues, and provide numerous advantages as set forth herein and as one skilled in the art will appreciate.

### SUMMARY

This section provides a general summary of the disclosure, and is not a comprehensive disclosure of its full scope or all of its features.

The present teachings include a three-dimensional imaging system for imaging an object of interest present in an area about a vehicle. The system includes a camera and a control module. The camera is configured to capture an image of the area about the vehicle including the object of interest. A control module of the system compares the captured image to previously captured model images including examples of the object of interest. The control module also identifies the object of interest in the captured image based on the comparison, and builds a three-dimensional reconstruction of the object of interest.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a three-dimensional imaging system according to the present teachings for imaging an object of interest present in an area about an exemplary vehicle;

FIG. 2 illustrates a method according to the present teachings for creating a three-dimensional reconstruction of an object of interest;

FIG. 3A illustrates an exemplary image of an area about a vehicle including an object of interest in the form of a road sign;

FIG. 3B illustrates exemplary image segmentation of the image of FIG. 3A; and

FIG. 4 illustrates identification of an object of interest in the form of an exemplary road sign in an area about a vehicle.

Corresponding reference numerals indicate corresponding parts throughout the several views of the drawings.

### DETAILED DESCRIPTION

Example embodiments will now be described more fully with reference to the accompanying drawings.

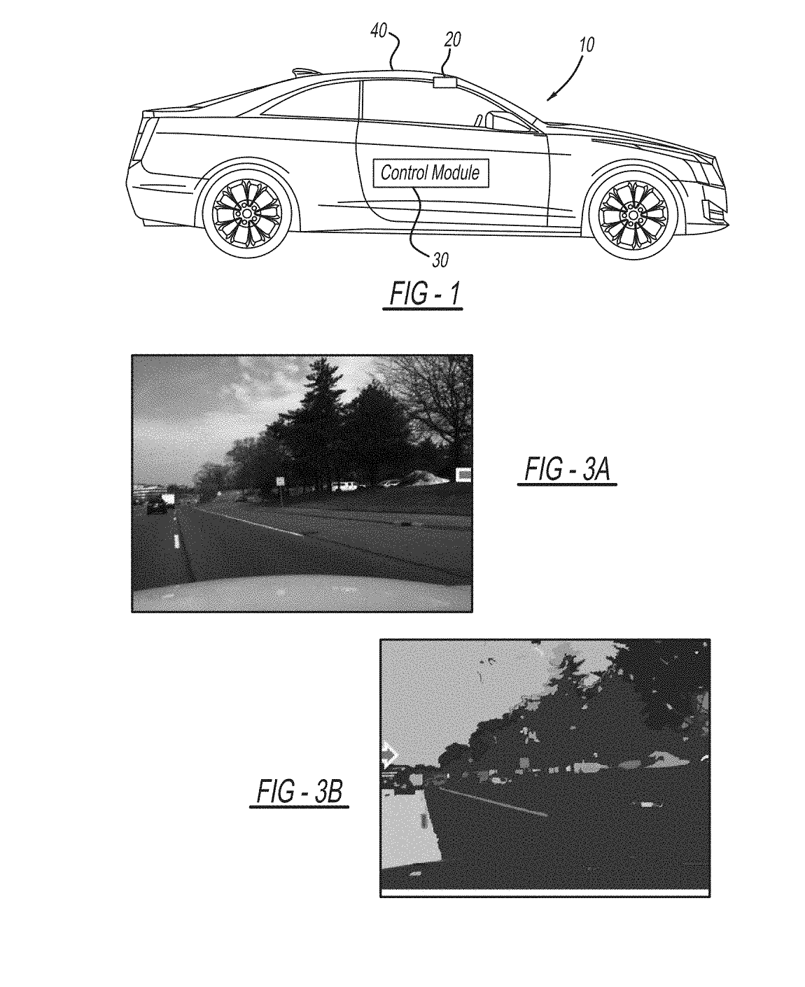

With initial reference to FIG. 1, the present teachings include a three-dimensional imaging system 10. The system 10 generally includes a camera 20 and a control module 30. FIG. 1 illustrates the system 10 included with an exemplary vehicle 40, such as part of a vehicle safety system and/or an autonomous driving system. Although the vehicle 40 is illustrated as a passenger vehicle, the system 10 can be used with any other suitable vehicle, such as a recreational vehicle, a mass transit vehicle, a construction vehicle, a military vehicle, a motorcycle, construction equipment, mining equipment, watercraft, aircraft, etc. Further, the system 10 can be used with non-vehicular applications in order to enhance the ability of the camera 20 to detect objects of interest. For example, the system 10 can be included with any suitable building security system, traffic management system, etc.

The system 10 is able to prepare a three-dimensional reconstruction of any suitable object of interest, such as, for example, any suitable road sign, traffic light, pedestrian, and/or any suitable type of infrastructure, such as an overpass, bridge, toll booth, construction zone, etc. The camera 20 can be any type of camera or sensing device capable of capturing images of one or more of such objects of interest present in an area about the vehicle 40. For example, the camera 20 can be a visible light camera, an infrared camera, etc. The camera 20 can be mounted at any suitable position about the vehicle 40, such as on a roof of the vehicle 40, at or near a front end of the vehicle 40, on a windshield of the vehicle 40, etc. The system 10 can include any suitable number of cameras 20, although the exemplary system described herein includes a single camera 20.

As explained further herein, the control module 30 receives an image taken by the camera 20 including an object of interest, and builds a three-dimensional image of the object of interest. In this application, including the definitions below, the term “module” may be replaced with the term “circuit.” The term “module” may refer to, be part of, or include processor hardware (shared, dedicated, or group) that executes code and memory hardware (shared, dedicated, or group) that stores code executed by the processor hardware. The code is configured to provide the features of the control module 30 described herein.

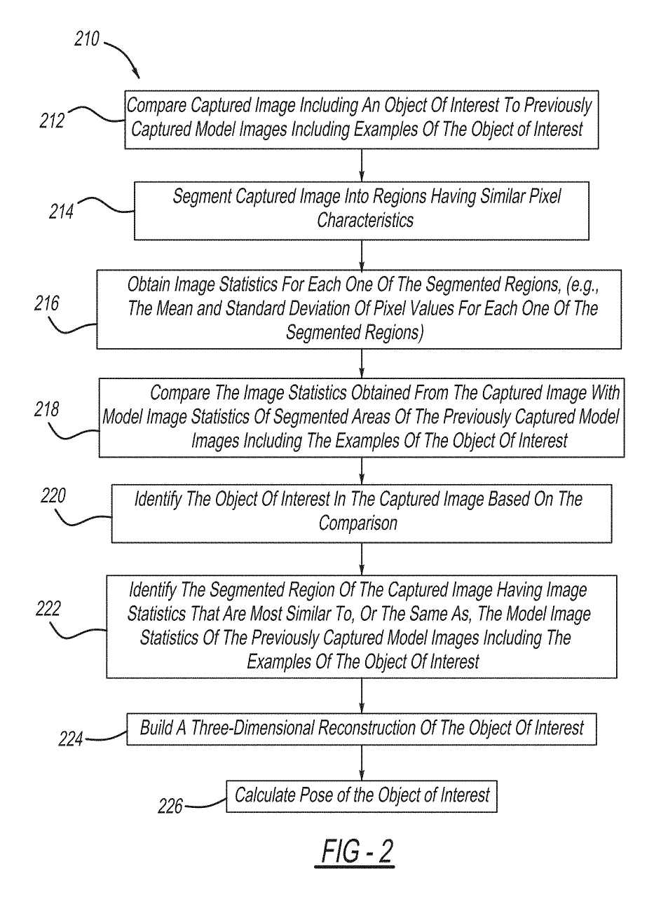

The control module 30 will now be described in conjunction with method 210 of FIG. 2 for exemplary purposes only. The method 210 creates a three-dimensional reconstruction of an object of interest in accordance with the present teachings. The method 210 can be performed by the control module 30, or by any other suitable control module or system. Thus, the method 210 is described as being performed by the control module 30 for exemplary purposes only.

The control module 30 is configured to compare the image captured by the camera 20 of the object of interest to previously captured model images including examples of the object of interest (e.g., objects that are similar to, or the same as, the object of interest). The previously captured model images including the objects of interest can be created and supplied in any suitable manner. For example, the previously captured model images can be captured by a manufacturer, distributor, or general provider of the system 10. The previously captured model images can be loaded to the control module 30 by the manufacturer, seller, or provider of the system 10, or can be obtained and loaded by a user of the system 10, such as by downloading the previously captured model images from any suitable source in any suitable manner, such as by way of an internet connection.

With reference to block 212 of the method 210, the control module 30 can compare the captured images to the previously captured model images including examples of the object of interest in any suitable manner. For example and with reference to block 214, the control module 30 can segment the captured image into regions having similar pixel characteristics, such as with respect to pixel brightness, color, etc. FIG. 3A illustrates an exemplary image of an area about the vehicle 40 with the object of interest in the form of a road sign. FIG. 3B illustrates the image of FIG. 3A after having undergone exemplary image segmentation performed by the control module 30. Any suitable segmentation technique can be used, such as efficient graph-based image segmentation (see, for example, “Efficient Graph-Based Image Segmentation” by Pedro F. Felzenszwalb & Daniel P. Huttenlocher (cs.brown.edu/˜pff/papers/seg-ijcv.pdf), which is incorporated herein by reference) or medical image segmentation using K-means clustering and improved watershed algorithm (see also, for example, “Medical Image Segmentation Using K-Means Clustering and Improved Watershed Algorithm” by H. P. Ng, et al. published in Image Analysis and Interpretation, 2006 IEEE Southwest Symposium, which is incorporated herein by reference).

With reference to block 216, the control module 30 obtains image statistics for each one of the segmented regions of the segmented image. Any image statistics suitable for identifying the object of interest can be obtained. For example, the mean and standard deviation of pixel values of each one of the segmented regions can be obtained by the control module 30. The control module 30 then compares the image statistics obtained from the captured images with model image statistics of segmented areas of the previously captured model images that are known to include examples of the object of interest, such as set forth at block 218.

With reference to block 220 of the method 210, the control module 30 identifies the object of interest in the captured image based on the comparison of the captured image to the previously captured model images that include examples of the object of interest. For example, the control module 30 can identify the object of interest in the captured image by identifying the segmented region of the captured image having image statistics that are most similar to, or the same as, the image statistics of the segment(s) of the previously captured model image(s) including an example of the object of interest, as set forth at block 222. In other words, if the object of interest is a road sign, the control module 30 identifies the segment(s) of the model image(s) having an exemplary road sign and the image characteristics of the segment(s). The control module 30 then determines which segment(s) of the captured image has image statistics that are most similar to, or the same as, the segment of the model image that is known to include a road sign, and identifies that segment of the captured image as having a road sign.

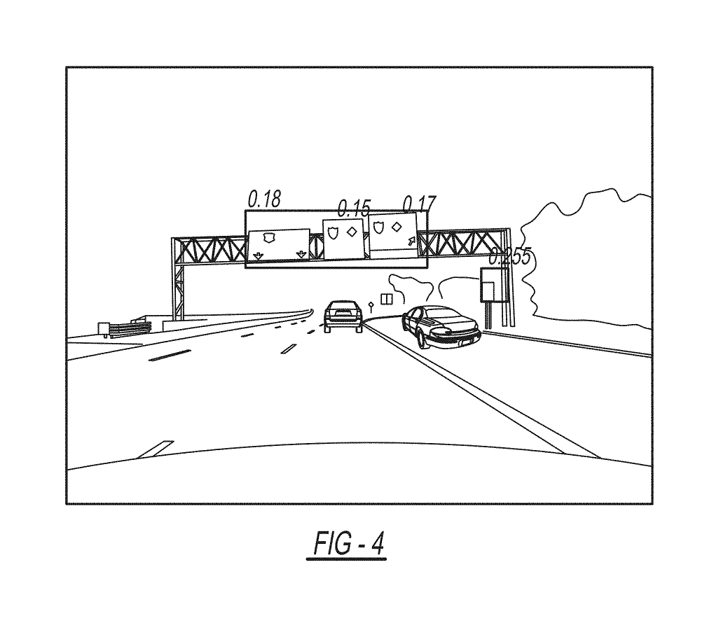

The control module 30 assigns a confidence value to each segment identified as including the object of interest, such as a road sign, as illustrated in FIG. 4 for example. The confidence value represents the confidence (or likelihood) that the segment contains the object of interest. The confidence values can be assigned in any suitable manner using any suitable technique. For example, each segment can be run through the machine learning model. The higher the confidence, the greater the likelihood that the object is of interest. Any suitable machine learning algorithm can be used, such as but not limited to the following: random forest (see, for example, www.stat.berkeley.edu/˜breiman/RandomForests/cc_home.htm, which is incorporated herein by reference); support vector machine (see, for example, www.robots.ox.ac.uk/˜az/lectures/ml/lect2.pdf, which is incorporated by reference herein); and convolutional neural network (see, for example, www.ufldl.stanford.edu/tutorial/supervised/convolutionalneuralnetwork, which is incorporated herein by reference). The one or more segments with confidence values that are above a predetermined threshold (meaning that the control module 30 has high confidence that the segment(s) contains the object of interest), are modeled three-dimensionally as set forth at block 224. Any suitable three-dimensional modeling/reconstruction can be used. For example, Structure from Motion (SfM) can be used (see, for example, http://mi.eng.cam.ac.uk/˜cipolla/publications/contributionTo EditedBook/2008-SFM-chapters.pdf, which is incorporated herein by reference).

Advantageously, the control module 30 builds a three-dimensional model of only the object(s) of interest. The control module 30 does not create a three-dimensional model of other objects in the image captured by the camera 20, which advantageously saves time and processing power. Thus when the vehicle 40 is traveling at a high rate of speed, the control module 30 can quickly identify objects of interest and create a three-dimensional reconstruction thereof.

With reference to block 226 of the method of FIG. 2, the three-dimensional reconstruction can be used to extract therefrom the position and orientation (“pose”) of the object of interest relative to the camera 20 and the vehicle 40. Based on the pose of the object of interest, the control module 30 can confirm whether or not the object three-dimensionally modeled is in fact the object of interest. It is also possible to extract how far away the object is from the vehicle, which is useful for tasks such as localization where the autonomous vehicle needs to determine where it is on a map.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for creating a three-dimensional reconstruction of an object of interest, the method comprising:
capturing an image of an area about a vehicle with a camera;
comparing the captured image to previously captured model images including examples of the object of interest;
identifying the object of interest in the captured image based on the comparison; and
building a three-dimensional reconstruction of the object of interest.

2. The method of claim 1, wherein the object of interest is a road sign.

3. The method of claim 1, wherein the object of interest is a traffic light.

4. The method of claim 1, wherein the object of interest is infrastructure.

5. The method of claim 1, wherein comparing the captured image to previously captured model images includes:
segmenting the captured image into regions having similar pixel characteristics;
obtaining image statistics for each one of the segmented regions, including the mean and standard deviation of pixel values in each one of the segmented regions; and
comparing the image statistics obtained from the captured image with model image statistics of areas of the previously captured model images including the examples of the object of interest.

6. The method of claim 5, wherein identifying the object of interest in the captured image includes:
identifying the segmented region of the captured image having image statistics that are most similar to, or the same as, the model image statistics for one or more segmented areas of the previously captured model images including the examples of the object of interest.

7. The method of claim 6, wherein building the three-dimensional reconstruction of the object of interest includes:
building a three-dimensional reconstruction of the segmented region of the captured image having image statistics that are most similar to, or the same as one or more of, the model image statistics of the previously captured model images including the examples of the object of interest.

8. The method of claim 1, wherein the three-dimensional reconstruction of the object includes only the object of interest.

9. A three-dimensional imaging system for imaging an object of interest present in an area about a vehicle, the system comprising:
a camera configured to capture an image of the area about the vehicle including the object of interest; and
a control module that:
compares the captured image to previously captured model images including examples of the object of interest;
identifies the object of interest in the captured image based on the comparison; and
builds a three-dimensional reconstruction of the object of interest.

10. The method of claim 9, wherein the object of interest is a road sign.

11. The method of claim 9, wherein the object of interest is a traffic light.

12. The method of claim 9, wherein the object of interest is infrastructure.

13. The method of claim 9, wherein when comparing the captured image to previously captured model images, the control module:
segments the captured image into regions having similar pixel characteristics;
obtains image statistics for each one of the segmented regions, including the mean and standard deviation of pixel values in each one of the segmented regions; and
compares the image statistics obtained from the captured image with model image statistics of areas of the previously captured model images including the examples of the object of interest.

14. The method of claim 13, wherein when identifying the object of interest in the captured image, the control module:
identifies the segmented region of the captured image having image statistics that are most similar to, or the same as, the model image statistics for one or more segmented areas of the previously captured model images including the examples of the object of interest.

15. The method of claim 14, wherein when building the three-dimensional reconstruction of the object, the control module:
builds a three-dimensional reconstruction of the segmented region of the captured image having image statistics that are most similar to, or the same as, one or more of the model image statistics of the previously captured model images including the examples of the object of interest.

16. The method of claim 9, wherein the control module builds a three-dimensional reconstruction of only the object of interest such that the three-dimensional reconstruction does not include other objects of the captured image.
